(19) United States
(12) Patent Application Publication
(10) Pub. No.: US 2018/0013131 A1
(43) Pub. Date: Jan. 11, 2018

(54) NEGATIVE ELECTRODE PLATE FOR NONAQUEOUS ELECTROLYTE SECONDARY BATTERY AND NONAQUEOUS ELECTROLYTE SECONDARY BATTERY INCLUDING NEGATIVE ELECTRODE PLATE

(71) Applicant: Sanyo Electric Co., Ltd., Daito-shi, Osaka (JP)

(72) Inventors: Satoshi Yamamoto, Osaka (JP); Yuki Suehiro, Osaka (JP)

(73) Assignee: Sanyo Electric Co., Ltd., Daito-shi, Osaka (JP)

(21) Appl. No.: 15/538,398

(22) PCT Filed: Jan. 18, 2016
(86) PCT No.: PCT/JP2016/000218

§ 371 Date: Jun. 21, 2017

(30) Foreign Application Priority Data
Jan. 27, 2015 (JP) 2015-013072

(51) Int. Cl. H01M 4/133; C08L 1/28; C08K 3/34; C08L 33/02; H01M 4/48; H01M 4/62; H01M 4/02; H01M 10/052

(52) U.S. Cl. CPC H01M 4/133; H01M 4/483; C08L 1/28; H01M 4/622; C08K 3/34; C08L 33/02; H01M 10/052; H01M 2004/027

(57) ABSTRACT

It is an object of the present invention to provide a negative electrode plate for a non-aqueous electrolyte secondary battery that has high capacity and good cycle characteristics and a non-aqueous electrolyte secondary battery. A negative electrode plate for a non-aqueous electrolyte secondary battery according to the present invention contains a negative-electrode active material containing a carbon material and a silicon oxide, carboxymethylcellulose, a polyacrylate partially neutralized by at least one of NaOH and NH₃, and a copolymer containing at least two selected from the group consisting of styrene, butadiene, methyl acrylate, methyl methacrylate, and acrylonitrile as constitutional units.

### TECHNICAL FIELD

The present invention relates to a negative electrode plate containing a carbon material and a silicon oxide for use in a non-aqueous electrolyte secondary battery and to a non-aqueous electrolyte secondary battery including the negative electrode plate.

### BACKGROUND ART

In recent years, non-aqueous electrolyte secondary batteries have been widely used as driving power supplies in portable electronic devices, such as smartphones, tablet computers, notebook computers, and portable music players. With the decrease in size and increase in functionality of these portable electronic devices, there has been a demand for non-aqueous electrolyte secondary batteries with higher capacity.

Carbon materials, such as graphite, are widely used as negative-electrode active materials of non-aqueous electrolyte secondary batteries. Carbon materials have a discharge potential comparable to lithium metal and can suppress lithium dendrite growth when charging. Thus, the use of carbon materials as negative-electrode active materials can improve the safety of non-aqueous electrolyte secondary batteries. For example, graphite can intercalate lithium ions up to the composition of LiC₆ and has a theoretical capacity of 372 mAh/g.

However, the capacity of existing carbon materials is already close to the theoretical capacity and is difficult to increase. Thus, in recent years, silicon materials, such as silicon and silicon oxides, which have higher capacity than carbon materials, have received attention as negative-electrode active materials of non-aqueous electrolyte secondary batteries. For example, silicon can intercalate lithium ions up to the composition of Li_{4.4}Si and has a theoretical capacity of 4200 mAh/g. Thus, the use of silicon materials as negative-electrode active materials can increase the capacity of non-aqueous electrolyte secondary batteries.

Like carbon materials, silicon materials can suppress lithium dendrite growth when charging. However, expansion and contraction associated with charging and discharging are greater in silicon materials than in carbon materials. Thus, breakdown of a negative-electrode active material powder or separation from the conductive network increases the electrode plate resistance and often causes deterioration of cycle characteristics.

Patent Literature 1 discloses a non-aqueous electrolyte secondary battery that contains a negative-electrode mixture containing SiO as a negative-electrode active material and poly(acrylic acid) as a binder. In this technique, the use of poly(acrylic acid) as a binder aims to improve the adhesion of the negative-electrode mixture itself and the adhesion between the negative-electrode mixture and a negative-electrode current collector, thereby preventing deterioration of the battery.

Patent Literature 2 discloses a non-aqueous electrolyte secondary battery that contains a negative-electrode mixture containing a negative-electrode active material SiO, on which a catalytic element is loaded to grow carbon nanofibers, and poly(acrylic acid) or polyacrylate as a binder. This technique aims not only to form a conductive network between SiO particles but also to solve the problem of reduced flexibility of the electrode plate due to the use of an acrylic acid polymer, such as poly(acrylic acid), as a binder.

Patent Literature 3 discloses a non-aqueous electrolyte secondary battery that includes a negative electrode plate containing a silicon oxide represented by the general formula SiOₓ (0.5≦x≦1.5) and graphite and a positive electrode plate containing a lithium transition metal oxide containing at least Ni and Mn. Patent Literature 3 discloses that a SiOₓ content of 20% or less by mass of the total mass of SiOₓ and graphite results in a slow deterioration in battery characteristics caused by the volume expansion of SiOₓ associated with charging and discharging.

### CITATION LIST

### Patent Literature

PTL 1: Japanese Published Unexamined Patent Application No. 2000-348730

PTL 2: Japanese Published Unexamined Patent Application No. 2006-339093

PTL 3: Japanese Published Unexamined Patent Application No. 2010-212228

### SUMMARY OF INVENTION

### Technical Problem

Expansion and contraction associated with charging and discharging are smaller in silicon oxides than silicon. When carbon materials are substituted by silicon oxides, however, the technique described in Patent Literature 1 or 2 by itself rarely provides sufficient cycle characteristics.

As described in Patent Literature 3, the use of a mixture of graphite and SiOₓ can reduce the effects of SiOₓ on cycle characteristics. However, this technique by itself rarely prevents a trade-off between capacity and cycle characteristics.

In view of such situations, it is an object of the present invention to improve the cycle characteristics of a non-aqueous electrolyte secondary battery containing a carbon material and a silicon oxide as negative-electrode active materials.

### Solution to Problem

In order to solve the problems, a negative electrode plate for a non-aqueous electrolyte secondary battery according to the present invention contains a negative-electrode active material containing a carbon material and a silicon oxide, carboxymethylcellulose, a poly(acrylic acid) partially neutralized by sodium hydroxide or ammonia, and a copolymer containing at least two selected from the group consisting of styrene, butadiene, methyl acrylate, methyl methacrylate, and acrylonitrile as constitutional units.

In the present invention, the poly(acrylic acid) is partially neutralized by sodium hydroxide or ammonia. The degree of neutralization of the poly(acrylic acid) is preferably, but not limited to, in the range of 0.2 to 0.8.

In order to solve the problems, a non-aqueous electrolyte secondary battery according to the present invention can include a negative electrode plate having the structure described above, a positive electrode plate, a separator, a non-aqueous electrolyte, and a housing.

### Advantageous Effects of Invention

The present invention can provide a negative electrode plate for a non-aqueous electrolyte secondary battery that has high capacity and good cycle characteristics and a non-aqueous electrolyte secondary battery.

### BRIEF DESCRIPTION OF DRAWINGS

FIG. 1 is a perspective view of a pouch-type non-aqueous electrolyte secondary battery used in examples and comparative examples.

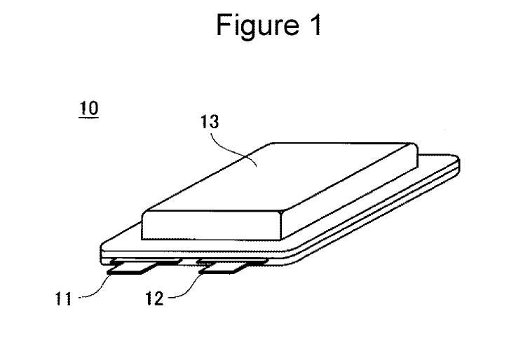

### DESCRIPTION OF EMBODIMENTS

A negative electrode plate for a non-aqueous electrolyte secondary battery according to an embodiment of the present invention can be manufactured by the following procedure. First, an active material, a thickener, and a binder are mixed, and the mixture is kneaded in a dispersion medium to produce a negative-electrode mixture slurry. The negative-electrode mixture slurry is applied to a negative-electrode current collector and is dried to form a negative-electrode mixture layer. The negative-electrode mixture layer is then pressed with a roller and is cut to a predetermined size. Thus, a negative electrode plate is produced.

In the present invention, a carbon material and a silicon oxide are used as negative-electrode active materials. The carbon material content and the silicon oxide content of the negative-electrode active material can be appropriately determined on the basis of the design capacity of the negative electrode plate. The silicon oxide content preferably ranges from 0.5% to 20% by mass of the mass of the negative-electrode active material.

The carbon material may be graphite, soft carbon, or non-graphitizable carbon and is particularly preferably graphite. Graphite may be artificial graphite or natural graphite. The carbon materials may be used alone or in combination.

The silicon oxide may be any compound composed of silicon and oxygen and is preferably a silicon oxide represented by the general formula SiOₓ (0.5≦x<1.6). SiOₓ preferably has a structure in which two fine phases, a Si phase and a SiO₂ phase, are dispersed in each particle.

The silicon oxide has higher surface resistivity than carbon materials and is therefore preferably covered with amorphous carbon. Amorphous carbon is applied by chemical vapor deposition (CVD), for example. More specifically, a hydrocarbon gas can be thermally decomposed in a nonoxidizing atmosphere to deposit amorphous carbon on the silicon oxide surface. The silicon oxide surface is not necessarily completely covered with amorphous carbon. The amount of the amorphous carbon preferably ranges from 0.1% to 10% by mass of the silicon oxide.

Carboxymethylcellulose (CMC) is used as a thickener. The carboxymethylcellulose (CMC) content can be appropriately determined to adjust the viscosity of the negative-electrode mixture slurry. The carboxymethylcellulose (CMC) content preferably ranges from 0.5% to 3% by mass of the negative-electrode active material.

Poly(acrylic acid) (PAA) functions as a thickener or binder. When the poly(acrylic acid) is neutralized by sodium hydroxide (NaOH) or ammonia (NH₃), protons of the carboxy groups of the poly(acrylic acid) are substituted by sodium ions (Na⁺) or ammonium ions (NH₄⁺). The degree of neutralization of the poly(acrylic acid) is preferably, but not limited to, in the range of 0.2 to 0.8. The degree of neutralization is calculated as the ratio of the number of neutralized carboxy groups to the number of carboxy groups bonded to the poly(acrylic acid) (PAA). The poly(acrylic acid) may have a cross-linked structure or a non-cross-linked structure.

The partially neutralized poly(acrylic acid) content preferably ranges from 0.05% to 5% by mass of the mass of the negative-electrode active material.

The partially neutralized poly(acrylic acid) preferably has a weight-average molecular weight in the range of 500,000 to 10,000,000. A weight-average molecular weight in this range results in slower gelation of a negative-electrode mixture slurry containing the partially neutralized poly(acrylic acid), thus making it easy to manufacture a negative electrode plate.

The present invention employs a copolymer containing at least two selected from the group consisting of styrene, butadiene, methyl acrylate, methyl methacrylate, and acrylonitrile as constitutional units. The copolymer functions as a binder. The copolymer preferably contains styrene and butadiene as constitutional units and more preferably consists of styrene and butadiene.

A negative electrode plate for a non-aqueous electrolyte secondary battery according to an embodiment of the present invention is described above. A non-aqueous electrolyte secondary battery according to an embodiment of the present invention will be described below.

A positive electrode plate can be manufactured in the same manner as the negative electrode plate using a positive-electrode active material. The positive-electrode active material may be a lithium transition metal oxide that can intercalate and deintercalate lithium ions. The lithium transition metal oxide may have the general formula LiMO₂ (M: at least one of Co, Ni, and Mn), LiMn₂O₄, or LiFePO₄. These may be used alone or in combination. At least one selected from the group consisting of Al, Ti, Mg, and Zr may be added to the lithium transition metal oxide, or may substitute for a transition metal element.

A separator is used to insulate the negative electrode plate from the positive electrode plate and is disposed between the negative electrode plate and the positive electrode plate. The separator may be a microporous membrane composed mainly of a polyolefin, such as polyethylene (PE) or polypropylene (PP). The microporous membrane may have a single layer or two or more layers. A separator composed of two or more layers preferably includes an intermediate layer composed mainly of a polyethylene (PE) with a low melting point and a surface layer formed of oxidation-resistant polypropylene (PP). Inorganic particles, such as aluminum oxide (Al₂O₃), titanium oxide (TiO₂), and silicon oxide (SiO₂), may be added to the separator. Such inorganic particles may be contained in the separator or, together with a binder, may be applied to the separator surface.

The non-aqueous electrolyte may contain a lithium salt as an electrolyte salt dissolved in a non-aqueous solvent. The non-aqueous electrolyte may contain a gel polymer, instead of or together with the non-aqueous solvent.

The non-aqueous solvent may be a cyclic carbonate, a linear carbonate, a cyclic carboxylate, or a linear carboxylate and is preferably a mixture of at least two of these. Examples of the cyclic carbonate include ethylene carbonate (EC), propylene carbonate (PC), and butylene carbonate (BC). A cyclic carbonate in which hydrogen is partly substituted by fluorine, such as fluoroethylene carbonate (FEC), may also be used. Examples of the linear carbonate include dimethyl carbonate (DMC), ethyl methyl carbonate (EMC), diethyl carbonate (DEC), and methyl propyl carbonate (MPC). Examples of the cyclic carboxylate include γ-butyrolactone (γ-BL) and γ-valerolactone (γ-VL). Examples of the linear carboxylate include methyl pivalate, ethyl pivalate, methyl isobutyrate, and methyl propionate.

Examples of the lithium salt include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, and Li₂B₁₂Cl₁₂. Among these, LiPF₆ is particularly preferred, and the concentration in the non-aqueous electrolyte preferably ranges from 0.5 to 2.0 mol/L. LiPF₆ may be mixed with another lithium salt, such as LiBF₄.

### EXAMPLES

Embodiments of the present invention will be described in detail with the following examples. The present invention is not limited to these examples, and various modifications may be made in them without departing from the gist of the present invention.

### Example 1

### (Preparation of Negative Electrode Plate)

Formed coke was graphitized by firing and was ground and classified to a predetermined size. The resulting graphite had an average particle size of 20 μm.

Silicon (Si) and silicon dioxide (SiO₂) were mixed and were heat-treated under reduced pressure, thus yielding a silicon oxide with a composition of SiO (x=1 in the general formula SiOₓ). The silicon oxide was ground and classified to adjust the particle size, and was covered with amorphous carbon in an argon atmosphere by chemical vapor deposition (CVD). The amount of the amorphous carbon was 5% by mass of the silicon oxide. The silicon oxide was crushed and classified to an average particle size of 10 μm.

95 parts by mass of the graphite and 5 parts by mass of the silicon oxide were mixed to produce a negative-electrode active material. 100 parts by mass of the negative-electrode active material, 1 part by mass of carboxymethylcellulose (CMC), 0.3 parts by mass of a poly(acrylic acid) (PAA) partially neutralized by sodium hydroxide (NaOH), and 1 part by mass of a copolymer containing styrene and butadiene as constitutional units were mixed. The degree of neutralization of the poly(acrylic acid) was 0.5. The mixture was kneaded in a dispersion medium, water, to produce a negative-electrode mixture slurry. The negative-electrode mixture slurry was applied to each side of a copper negative-electrode current collector with a thickness of 10 μm by a doctor blade method and was dried to form a negative-electrode mixture layer. Finally, the negative-electrode mixture layer was pressed with a roller and was cut to a predetermined size, thus preparing a negative electrode plate.

### (Preparation of Positive Electrode Plate)

Cobalt carbonate (CoCO₃) was thermally decomposed at 550° C. to produce tricobalt tetroxide (Co₃O₄). The tricobalt tetroxide and a lithium source, lithium carbonate, were mixed at a cobalt/lithium mole ratio of 1:1 in a mortar. The mixture was fired in an air atmosphere at 850° C. for 20 hours to produce lithium cobalt oxide (LiCoO₂). The lithium cobalt oxide was ground in a mortar to an average particle size of 15 μm, thus producing a positive-electrode active material.

96.5 parts by mass of the lithium cobalt oxide, 1.5 parts by mass of a carbon powder serving as a conductive agent, and 2 parts by mass of a poly(vinylidene difluoride) (PVdF) binder were mixed. The mixture was kneaded in an N-methylpyrrolidone (NMP) dispersion medium to produce a positive-electrode mixture slurry. The positive-electrode mixture slurry was applied to each side of an aluminum positive-electrode current collector with a thickness of 15 μm by a doctor blade method and was dried to form a positive-electrode mixture layer. Finally, the positive-electrode mixture layer was pressed with a roller and was cut to a predetermined size, thus preparing a positive electrode plate.

The amounts of applied negative-electrode active material and positive-electrode active material were adjusted such that the charge capacity ratio of the positive electrode and the negative electrode (the charge capacity of the negative electrode/the charge capacity of the positive electrode) was 1.1 at the electric potential of the positive-electrode active material serving as a design criterion.

### (Preparation of Non-Aqueous Electrolytic Solution)

Ethylene carbonate (EC) and methyl ethyl carbonate (MEC) were mixed at a volume ratio of 30:70 to produce a non-aqueous solvent. Lithium hexafluorophosphate (LiPF₆) was dissolved in the non-aqueous solvent at a concentration of 1 mol/L. Vinylene carbonate (VC) and fluoroethylene carbonate (FEC) were added to the non-aqueous solvent to produce a non-aqueous electrolytic solution. The amount of each of the vinylene carbonate and fluoroethylene carbonate was 1% by mass of the mass of the non-aqueous electrolytic solution.

### (Manufacture of Non-Aqueous Electrolyte Secondary Battery)

The negative electrode plate and the positive electrode plate were coupled to a nickel negative-electrode lead 11 and an aluminum positive-electrode lead 12, respectively. The negative electrode plate and the positive electrode plate were wound in a flat form with a polyethylene microporous membrane separator interposed therebetween, thus manufacturing a wound electrode assembly.

A housing of the electrode assembly was a laminated housing 13 formed of a laminated sheet. The laminated sheet had a 5-layer structure of resin layer (polypropylene)/adhesive layer/aluminum alloy layer/adhesive layer/resin layer (polypropylene). The laminated sheet was partly formed into a cup with a space for housing the electrode assembly, thus forming the laminated housing 13. The electrode assembly and the non-aqueous electrolyte were placed in the laminated housing 13, thus manufacturing a pouch-type non-aqueous electrolyte secondary battery 10 with a design capacity of 800 mAh.

### Example 2

A non-aqueous electrolyte secondary battery according to Example 2 was manufactured in the same manner as in Example 1 except that the degree of neutralization of the poly(acrylic acid) was 0.8.

### Example 3

A non-aqueous electrolyte secondary battery according to Example 2 was manufactured in the same manner as in Example 1 except that the degree of neutralization of the poly(acrylic acid) was 0.2.

### Example 4

A non-aqueous electrolyte secondary battery according to Example 4 was manufactured in the same manner as in Example 1 except that the copolymer contained styrene and methyl acrylate as constitutional units.

### Example 5

A non-aqueous electrolyte secondary battery according to Example 5 was manufactured in the same manner as in Example 1 except that the copolymer contained styrene and methyl methacrylate as constitutional units.

### Example 6

A non-aqueous electrolyte secondary battery according to Example 6 was manufactured in the same manner as in Example 1 except that the copolymer contained methyl methacrylate and acrylonitrile as constitutional units.

### Example 7

A non-aqueous electrolyte secondary battery according to Example 7 was manufactured in the same manner as in Example 1 except that the poly(acrylic acid) content was 0.05% by mass of the negative-electrode active material.

### Example 8

A non-aqueous electrolyte secondary battery according to Example 8 was manufactured in the same manner as in Example 1 except that the poly(acrylic acid) content was 1% by mass of the negative-electrode active material.

### Example 9

A non-aqueous electrolyte secondary battery according to Example 9 was manufactured in the same manner as in Example 1 except that the poly(acrylic acid) content was 5% by mass of the negative-electrode active material.

### Example 10

A non-aqueous electrolyte secondary battery according to Example 10 was manufactured in the same manner as in Example 1 except that the poly(acrylic acid) was neutralized with ammonia (NH₃).

### Comparative Example 1

A non-aqueous electrolyte secondary battery according to Comparative Example 1 was manufactured in the same manner as in Example 1 except that no poly(acrylic acid) was used.

### Comparative Example 2

A non-aqueous electrolyte secondary battery according to Comparative Example 2 was manufactured in the same manner as in Example 1 except that no carboxymethylcellulose was used.

### Comparative Example 3

A non-aqueous electrolyte secondary battery according to Comparative Example 3 was manufactured in the same manner as in Example 1 except that no copolymer was used.

### Comparative Example 4

A non-aqueous electrolyte secondary battery according to Comparative Example 4 was manufactured in the same manner as in Example 1 except that neither carboxymethylcellulose nor copolymer was used.

### Comparative Example 5

A non-aqueous electrolyte secondary battery according to Comparative Example 5 was manufactured in the same manner as in Example 1 except that the degree of neutralization of the poly(acrylic acid) was 1.

### Comparative Example 6

A non-aqueous electrolyte secondary battery according to Comparative Example 6 was manufactured in the same manner as in Example 1 except that the degree of neutralization of the poly(acrylic acid) was 0.

### (Cycle Test)

The batteries according to Examples 1 to 10 and Comparative Examples 1 to 6 were subjected to a cycle test under the following conditions. First, a battery was charged at a constant current of 1 It=800 mA to a battery voltage of 4.4 V and then at a constant voltage of 4.4 V to an electric current of 1/20 It=40 mA. The battery was then discharged at a constant current of 1 It=800 mA to a battery voltage of 3.0 V. 300 cycles of the charging and discharging were performed at 25° C., and the discharge capacity of the first cycle and the discharge capacity of the 300th cycle were measured. The capacity retention rate after 300 cycles was calculated using the following formula. Table 1 summarizes the results.

Capacity retention rate after 300 cycles (%)=(Discharge capacity at 300th cycle/Discharge capacity at first cycle)×100

TABLE 1

| | | | | | | Capacity |
|---|---|---|---|---|---|---|
| | | | | | | retention |
| | CMC | PAA | Degree of | Neutralizing | Constitutional | rate after |
| | content | content | neutralization | agent for | units of | 300 cycles |
| | (mass %) | (mass %) | of PAA | PAA | copolymer | (%) |
| Example 1 | 1 | 0.3 | 0.5 | NaOH | styrene/butadiene | 90 |
| Example 2 | 1 | 0.3 | 0.8 | NaOH | styrene/butadiene | 91 |
| Example 3 | 1 | 0.3 | 0.2 | NaOH | styrene/butadiene | 92 |
| Example 4 | 1 | 0.3 | 0.5 | NaOH | styrene/methyl | 90 |
| | | | | | acrylate | |
| Example 5 | 1 | 0.3 | 0.5 | NaOH | styrene/methyl | 90 |
| | | | | | methacrylate | |
| Example 6 | 1 | 0.3 | 0.5 | NaOH | methyl | 90 |
| | | | | | methacrylate/ | |
| | | | | | acrylonitrile | |
| Example 7 | 1 | 0.05 | 0.5 | NaOH | styrene/butadiene | 90 |
| Example 8 | 1 | 1 | 0.5 | NaOH | styrene/butadiene | 92 |
| Example 9 | 1 | 5 | 0.5 | NaOH | styrene/butadiene | 90 |
| Example 10 | 1 | 0.3 | 0.5 | NH₃ | styrene/butadiene | 90 |
| Comparative | 1 | 0 | — | — | styrene/butadiene | 82 |
| example 1 | | | | | | |
| Comparative | 0 | 0.3 | 0.5 | NaOH | styrene/butadiene | 80 |
| example 2 | | | | | | |
| Comparative | 1 | 0.3 | 0.5 | NaOH | — | 85 |
| example 3 | | | | | | |
| Comparative | 0 | 0.3 | 0.5 | NaOH | — | 83 |
| example 4 | | | | | | |
| Comparative | 1 | 0.3 | 1 | NaOH | styrene/butadiene | 74 |
| example 5 | | | | | | |
| Comparative | 1 | 0.3 | 0 | — | styrene/butadiene | 81 |
| example 6 | | | | | | |

CMC: Carboxymethylcellulose
FAA: Poly(acrylic acid)

Table 1 shows that Examples 1 to 10 have a capacity retention rate of 90% or more. By contrast, Comparative Examples 1 to 3, which did not contain one of the carboxymethylcellulose, partially neutralized poly(acrylic acid), and copolymer, have a capacity retention rate of 85% or less. Thus, lack of any one of these three constituents results in very poor cycle characteristics. However, a comparison of Comparative Example 3 with Comparative Example 4 shows that when the negative electrode plate contained no copolymer, lack of carboxymethylcellulose does not significantly reduce the capacity retention rate. This result suggests that the organic relationship between the three constituents of carboxymethylcellulose, partially neutralized poly(acrylic acid), and copolymer improves the cycle characteristics.

The capacity retention rates of Comparative Example 5, in which the degree of neutralization of poly(acrylic acid) was 1, and Comparative Example 6, in which the degree of neutralization of poly(acrylic acid) was 0, were much lower than those of Examples 1 to 3, in which the degree of neutralization ranged from 0.2 to 0.8. This proves the importance of partial neutralization of poly(acrylic acid). Since the capacity retention rates of Examples 1 to 3 are almost the same, the cycle characteristics would be improved even using a poly(acrylic acid) partially neutralized such that the degree of neutralization is outside the range of 0.2 to 0.8.

With respect to the poly(acrylic acid) content, since the capacity retention rates of Examples 1, 7, and 8 are almost the same, the cycle characteristics would also be improved even when the poly(acrylic acid) content is outside the range of 0.05% to 5% by mass of the negative-electrode active material.

With respect to the constitutional units of the copolymer, the results of Examples 1 and 4 to 6 show that the cycle characteristics can be effectively improved as long as the constitutional units of the copolymer are styrene, butadiene, methyl acrylate, methyl methacrylate, and acrylonitrile. Although only the copolymers composed of two constitutional units were used in the examples, three or more of the constitutional units may be used in combination.

Examples 1 and 10 show that the use of ammonia instead of sodium hydroxide as a neutralizing agent for poly(acrylic acid) also has the advantages of the present invention.

Although the pouch-type housing formed of the laminated sheet was used in the examples, metallic housing cans may also be used. Examples of the housing cans include cylindrical housing cans and square and rectangular housing cans.

### INDUSTRIAL APPLICABILITY

The present invention can provide a negative electrode plate for a non-aqueous electrolyte secondary battery that has high capacity and good cycle characteristics and a non-aqueous electrolyte secondary battery including the negative electrode plate. Thus, the present invention has wide industrial applicability.

### REFERENCE SIGNS LIST

10 Non-aqueous electrolyte secondary battery
11 Negative-electrode lead
12 Positive-electrode lead
13 Laminated housing

1. A negative electrode plate for a non-aqueous electrolyte secondary battery, comprising:
a negative-electrode active material containing a carbon material and a silicon oxide;
carboxymethylcellulose;
a poly(acrylic acid) partially neutralized by at least one of sodium hydroxide and ammonia; and
a copolymer containing at least two selected from the group consisting of styrene, butadiene, methyl acrylate, methyl methacrylate, and acrylonitrile as constitutional units.

2. The negative electrode plate for a non-aqueous electrolyte secondary battery according to claim 1, wherein the poly(acrylic acid) has a degree of neutralization in the range of 0.2 to 0.8.

3. The negative electrode plate for a non-aqueous electrolyte secondary battery according to claim 1, wherein the partially neutralized poly(acrylic acid) content ranges from 0.05% to 5% by mass of the negative-electrode active material.

4. The negative electrode plate for a non-aqueous electrolyte secondary battery according to claim 1, wherein the copolymer contains styrene and butadiene.

5. The negative electrode plate for a non-aqueous electrolyte secondary battery according to claim 1, wherein the partially neutralized poly(acrylic acid) has a weight-average molecular weight in the range of 500,000 to 10,000,000.

6. The negative electrode plate for a non-aqueous electrolyte secondary battery according to claim 1, wherein the silicon oxide is represented by the general formula SiOₓ (0.5≦x≦1.6).

7. The negative electrode plate for a non-aqueous electrolyte secondary battery according to claim 1, wherein the silicon oxide content of the negative-electrode active material ranges from 0.5% to 20% by mass.

8. A non-aqueous electrolyte secondary battery, comprising: the negative electrode plate according to claim 1, a positive electrode plate, a separator, a non-aqueous electrolyte, and a housing.
